(19) United States
(12) Patent Application Publication
(10) Pub. No.: US 2024/0367206 A1
(43) Pub. Date: Nov. 7, 2024

(54) CLEANING SYSTEM FOR CLEANING CONTAINER UNITS, DRYING APPARATUS FOR DRYING, AND METHOD

(71) Applicant: BELVAC PRODUCTION MACHINERY, INC., Lynchburg, VA (US)

(72) Inventors: Wilko HARMS, Wittmund (DE); Ulf REINHARDT, Teutschenthal (DE)

(21) Appl. No.: 18/571,029

(22) PCT Filed: Jun. 15, 2022
(86) PCT No.: PCT/EP2022/066320

§ 371 Date: Dec. 15, 2023

(30) Foreign Application Priority Data
Jun. 16, 2021 (DE) 10 2021 115 584.3

(51) Int. Cl. B08B 9/30; B08B 9/42; F26B 3/04; F26B 15/18; F26B 21/10; F26B 21/12

(52) U.S. Cl. CPC B08B 9/30; B08B 9/42; F26B 3/04; F26B 15/18; F26B 21/10; F26B 21/12; B08B 2209/08

(57) ABSTRACT

The invention relates to a cleaning system (100) for cleaning container units (2), in particular cans, comprising a movement device (102), which is arranged and designed to move container bundles containing a plurality of container units (2) along a cleaning path, at least one cleaning device (106-120), which is arranged and designed to clean the container units (2) within at least one cleaning portion of the cleaning path, and a control device, which is signal-coupled to the cleaning device (106-120) and/or the movement device (102), which is configured to put the cleaning device (106-120) into an energy-saving mode when a predefined bundle spacing between two successive container bundles (1, 1′, 1″) is exceeded, and/or to set a movement speed for the movement device (102) in such a manner that a bundle spacing (126, 128) between two successive container bundles (1, 1′, 1″) is less than the predefined bundle spacing.

### CROSS-REFERENCE TO RELATED APPLICATIONS

This application is a U.S. national stage of International Application No. PCT/EP2022/066320, filed Jun. 15, 2022, which claims the benefit of and priority to German Patent Application No. 10 2021 115 584.3, filed Jun. 16, 2021, each of which is hereby incorporated by reference herein in its entirety.

### FIELD

The invention relates to a cleaning system for cleaning container units, a drying device for drying cleaned container units, a method for cleaning container units, and a method for drying cleaned container units.

### BACKGROUND

Cleaning systems for cleaning container units, particularly cans, are known in principle. Such cleaning systems usually comprise a conveyor belt with which the cans are moved along a cleaning path and pass through various cleaning devices with different cleaning principles.

Controlling the cleaning devices and the individual components of the cleaning devices, for example cleaning nozzles, is complex. Due to this, in practice the cleaning devices are usually controlled in an operating mode that is substantially independent of the number of cans introduced.

Cans are typically moved through the cleaning system in container bundles to ensure stabilization of individual cans by adjacent cans. A fallen can is usually a reject. For this purpose, the cans are collected upstream of the cleaning system and subsequently packed tightly in the form of a container bundle and moved through the cleaning system.

Due to the collection of the cans before the cleaning system, it is often the case, depending on the load, that a bundle empty point occurs between two consecutive container bundles, so that the two consecutive container bundles are spaced apart by a bundle distance. Up to a determined bundle spacing, this is not or only slightly relevant for the controller of the cleaning system. However, the greater the bundle spacing, the greater the energy wasted by the cleaning system in the overall can manufacturing process.

CN 2 08 004 467 U discloses an energy-saving can cleaning machine comprising a plurality of automatic conveyor belts and a control system. DE 10 2019 115 198 A1 discloses a method and a device for distributing and/or grouping containers in a container treatment system. The device has an infeed conveying apparatus, an outfeed conveying apparatus, and a transfer conveying apparatus. The transfer conveying apparatus has a guide track and several movement devices, which can be driven individually, preferably by means of a long-stator linear motor, and which are guided along the guide track.

One goal in the production of containers, particularly cans, is to ensure high resource efficiency. In particular, it is also a goal to reduce the ecological footprint of each individual can. At the same time, it is a goal to make the production of containers, particularly cans, efficient, since a saving per individual can has a high impact on the overall efficiency, since usually several million or several billion of one can are produced.

It is therefore an object of the invention to provide a cleaning system for cleaning container units, a drying device for drying cleaned container units, a method for cleaning container units, and a method for drying cleaned container units that reduce or eliminate one or more of said disadvantages. In particular, it is an object of the invention to provide a solution that enables resource-saving production of container units, especially cans.

This object is achieved with a cleaning system, a drying device, and the methods according to the features of the independent patent claims. Further advantageous embodiments of these aspects are given in the respective dependent patent claims. The features listed individually in the patent claims and the description can be combined with one another in any technologically useful manner, wherein further embodiments of the invention are shown.

### SUMMARY

According to one embodiment, a cleaning system for cleaning container units, in particular cans, is disclosed. The system includes a movement device arranged and designed to move container bundles including a plurality of container units along a cleaning path. The system further includes at least one cleaning device arranged and designed to clean the container units within at least one cleaning portion of the cleaning path. The system further includes a control device signal-coupled to the at least one cleaning device and/or the movement device. The control device signal is configured to put the at least one cleaning device into an energy-saving mode when a predefined bundle spacing between two successive container bundles is exceeded, and/or to set a movement speed of the movement device in such a manner that a bundle spacing between two successive container bundles is smaller than the predefined bundle spacing.

According to another embodiment, a drying device for drying cleaned container units is disclosed. The drying device includes a second movement device for moving cleaned container bundles including a plurality of cleaned container units along a drying path. The drying device further includes a drying unit for applying a drying fluid to the cleaned container units at least in portions along the drying path. The drying device further includes a second control device, which is signal-coupled to the drying unit and is configured to adjust the drying unit as a function of a bundle spacing between two successive cleaned container bundles.

According to another embodiment, a method for drying cleaned container units is disclosed. The method includes moving cleaned container bundles including a plurality of cleaned container units along a drying path at a movement speed. The method further includes applying a drying fluid to the cleaned container units. The method further includes providing the drying fluid as a function of a bundle spacing-between two successive cleaned container bundles.

### BRIEF DESCRIPTION OF THE DRAWINGS

Preferred exemplary embodiments are explained with reference to the accompanying figures. In the figures:

FIG. 1: shows a two-dimensional, schematic view of an exemplary embodiment of a cleaning system;

FIG. 2: shows a schematic, two-dimensional top view of the cleaning system shown in FIG. 2;

FIG. 3: shows a schematic, two-dimensional view of an exemplary embodiment of a cleaning device;

FIG. 4: shows a schematic, two-dimensional view of an exemplary embodiment of a drying device;

FIG. 5: shows a schematic view of an exemplary method for cleaning container units; and

FIG. 6: shows a schematic view of an exemplary method for drying cleaned container units.

In the figures, identical or substantially functionally identical or similar elements are designated by the same reference numerals.

### DETAILED DESCRIPTION

In accordance with a first aspect, the object is achieved by a cleaning system for cleaning container units, in particular cans, comprising a movement device, which is arranged and designed to move container bundles containing a plurality of container units along a cleaning path, at least one cleaning device, which is arranged and designed to clean the container units within at least one cleaning portion of the cleaning path, and a control device, which is signal-coupled to the at least one cleaning device and/or the movement device, which is configured to put the at least one cleaning device into an energy-saving mode when a predefined bundle spacing between two successive container bundles is exceeded, and/or to set a movement speed for the movement device in such a manner that a bundle spacing between two successive container bundles is smaller than the predefined bundle spacing.

The invention is based on the realization that large bundle spacing can be used to reduce the energy consumption of the cleaning system. Although a primary goal in the production of container units, particularly cans, is to ensure high process reliability, there is an opportunity to reduce energy consumption when taking bundle spacing into account.

In particular, by using information representing a large bundle spacing, the cleaning device can be put into an energy saving mode to reduce the energy consumption of the cleaning system. The invention is further based on the realization that only minor modifications to a cleaning system are required to implement the control device mentioned in the foregoing.

In particular, the movement device is a conveyor belt with fluid-permeable openings. For example, the movement device may comprise a metal mesh.

The at least one cleaning device is arranged and designed to clean the container units within at least one cleaning portion of the cleaning path. The at least one cleaning device is particularly arranged and designed to apply a cleaning fluid to the container units vertically from below. The container units are usually moved by the movement device in such a manner that their open end is directed downwards and their closed end is directed upwards. As a result, interior spaces of the container units are impacted with the cleaning fluid when it is directed vertically upward from the cleaning device into the interior spaces of the container units.

It is particularly preferred that the cleaning system comprises two or more cleaning devices. It is further preferred that a cleaning device for pre-rinsing, a cleaning device for pre-washing, a cleaning device for rinsing, a cleaning device for washing, a cleaning device for further rinsing, a cleaning device for chemical treating, a cleaning device for further rinsing and/or a cleaning device for surface treating is provided.

Furthermore, the cleaning system comprises the control device signal-coupled to the cleaning device and/or the movement device. The control device is configured to place the cleaning device in a energy-saving mode when a predefined bundle distance between two consecutive container bundles is exceeded, in such a way that, in particular, the cleaning device is in the energy-saving mode when a bundle empty point between two consecutive container bundles is moved by the cleaning device. As a result, the cleaning device is in an energy-saving mode when the bundle empty point is moved through the cleaning device. As a result, as the bundle empty point is moved through the cleaning device, less or no energy is consumed by the cleaning device.

Alternatively or additionally, the movement speed of the movement device is adjusted in such a manner that the bundle spacing between two successive container bundles is less than the predefined bundle spacing. By reducing the speed of movement, the bundle spacing can be reduced, for example. When the movement speed is reduced, it is also preferable that cleaning parameters are adjusted so that, for example, an exposure time of chemical substances remains within a predetermined period of time. This will be explained more below. The predefined bundle spacing can also be zero.

It is preferred that the cleaning system has a downholder for holding down the container units. During operation of the cleaning system, the container units are preferably located between the movement device and the downholder, at least in portions along the cleaning path, so that they are further protected against tipping over. The downholder can be designed as an elastic band, for example.

In a preferred embodiment of the cleaning system, the control device is configured to idle and/or deactivate the cleaning device when the cleaning device is placed in the energy-saving mode.

A further preferred embodiment of the cleaning system is characterized in that it comprises a distance detection unit signal-coupled to the control device, which is arranged and designed to detect the bundle distance between two successive container bundles. By means of such a distance detection unit, the bundle distance can be detected continuously or at intervals and the at least one cleaning device and/or the movement device can be controlled based on the detected bundle distance.

It is particularly preferred that the distance detection unit generates and/or provides a distance signal characterizing the bundle spacing. The control device is particularly designed to receive the distance signal.

Alternatively, the distance signal may be provided by the unit not comprised by the cleaning system and received by the control device.

In another preferred embodiment of the cleaning system, the control device is configured to compare the bundle spacing between two successive container bundles with the predefined bundle spacing. The predefined bundle spacing can be stored in the control device, for example. Alternatively, the predefined bundle spacing can also be entered by an operator at the control device, for example. By comparing the bundle spacing with the predefined bundle spacing, it can be determined whether the cleaning device is to be set to energy-saving mode and/or the movement speed of the movement device is to be adjusted, in particular varied, in particular reduced.

Another preferred embodiment of the cleaning system is characterized by the fact that the distance detection unit is or comprises a light barrier, in particular an infrared light barrier. Furthermore, the distance detection unit may generally comprise or be designed as optical sensors, distance sensors, for example based on sound or laser, inductive and capacitive sensors, magnetic sensors, and camera systems.

A further preferred embodiment of the cleaning system comprises a temperature control unit, which is signal-coupled to the control device, for tempering a cleaning fluid, wherein the control device is configured to control the temperature control unit as a function of the bundle spacing and/or the movement speed. For example, it may also be part of the energy-saving mode to control the temperature control unit in such a manner that the temperature of the cleaning fluid is reduced. In addition, it may be provided that the lower the movement speed, the lower the fluid temperature.

Another preferred embodiment of the cleaning system provides that the cleaning device has a plurality of cleaning units for dispensing the cleaning fluid, which are arranged and configured in such a manner that they can be deactivated individually and/or in groups, wherein the control device is configured to deactivate the cleaning units depending on the movement speed and/or the bundle spacing.

For example, when a large bundle spacing is detected, it can be useful to deactivate the cleaning units until the bundle empty point has passed the cleaning device. The cleaning units can also be deactivated in groups, for example.

A further preferred embodiment of the cleaning system is characterized in that the cleaning units each have cleaning nozzles for dispensing the cleaning fluid and the cleaning nozzles can be separately controlled by the control device in such a manner that the cleaning nozzles can be separately deactivated.

The cleaning device may further have one, two or more pumps fluidly coupled to the cleaning units and/or the cleaning nozzles. It is particularly preferred that a pump is designed to supply cleaning fluid to two or more cleaning units. In addition, it is preferred that the one, two or more pumps are signal-coupled to the control device and the control device is configured to control the pump or pumps individually, in particular to deactivate them and/or put them into idle mode, in such a way that two or more cleaning units are deactivated when one pump is deactivated, for example.

It is particularly preferred that the control device is configured to control the pumps in such a way that when one, two or more cleaning nozzles for a cleaning unit are deactivated, the fluid pressure at the remaining cleaning nozzle or nozzles for that cleaning unit remains substantially constant.

A further preferred embodiment of the cleaning system provides that the cleaning fluid has a predefined exposure time and the control device is configured to control the cleaning device, in particular the cleaning units, preferably the cleaning nozzles, further preferably the pump(s) and/or to set the movement speed in such a way that the container units are exposed to the cleaning fluid for a cleaning time, wherein the cleaning time substantially corresponds to the exposure time. Substantially corresponding to the exposure time means, in particular, that specified tolerances of the exposure time are observed.

If, for example, a container unit enters the cleaning device and is wetted there with the cleaning fluid, the movement speed can be used to determine the time after which the container unit leaves the cleaning device and is rinsed by means of a second fluid flow device described in more detail below.

If the movement speed is low, for example, it may be useful to wet the container unit with the cleaning fluid not with a cleaning unit at the beginning of the cleaning device, but, for example, with a cleaning unit in the middle of the cleaning device, in such a way that the cleaning time until the container unit exits the cleaning device substantially corresponds to the predefined exposure time. The exposure time can also be a period of time, for example, 30 seconds to 60 seconds.

Another preferred embodiment of the cleaning system comprises a first fluid flow device arranged and designed to evacuate a fluid, particularly air, from the cleaning device. Evacuation here means, in particular, that the fluid is removed from the cleaning device, for example, pumped out. The first fluid flow device may be designed as a fan, for example. Inside the cleaning device, the air is enriched with the cleaning fluid, so it can be advantageous to change this air regularly for cleaning the container units. The first fluid flow device is preferably signal-coupled to the control device and can be controlled by the latter, for example, in such a manner that a predefined fluid flow is generated.

Another preferred embodiment of the cleaning system is characterized in that it comprises two cleaning devices, wherein a second fluid flow device is arranged and designed between the two cleaning devices in such a way as to remove cleaning fluid from the container units. The second fluid flow device may have, for example, a second fan unit for applying a fluid flow to the container units. In particular, this fluid flow is directed vertically downward. In addition, the second fluid flow device may have a fluid suction unit that sucks the fluid flow vertically downward. Preferably, the second fan unit and the fluid suction unit are arranged vertically one above the other.

In another preferred embodiment of the cleaning system, the cleaning system is provided to have a guide device arranged and designed to link the container units to an adjustable side portion of the movement device. For example, the side portion may extend from a longitudinal side of the movement device ⅓ or ⅔ of a width of the movement device oriented orthogonally to a direction of movement of the container units with a side portion width that is particularly less than the width of the movement device. An empty portion is provided in the direction of the width adjacent to the side portion. The side portion width is adjustable and may be equal to the width of the movement device, in which case the blank portion has a width of zero, or less than the width of the movement device.

The guide device is further arranged and designed substantially to guide no container units into the empty portion. For example, the guide device may be designed as a barrier for the container units, arranged and designed to clear only the side portion for the container units. Consequently, no container units can enter the empty portion. The guide device can be arranged, for example, in front of an inlet of the cleaning system.

In accordance with another preferred embodiment of the cleaning system, the cleaning device is arranged and designed to clean the container units within the side portion and not clean the empty portion.

In particular, it is preferred that the energy-saving mode is configured in such a way that the cleaning device cleans the container units in the side portion and the cleaning units and/or cleaning nozzles for the empty portion are deactivated. As a result, the movement speed can remain constant, so that the exposure time of the cleaning fluid does not have to be taken into account. Nevertheless, energy is saved in such a way that the cleaning device does not clean the empty portion or only cleans it to a reduced extent.

It is furthermore preferred that the movement device has a stabilizing element arranged and designed to position the container units in the direction of the empty portion. This ensures that the outer container units of a container bundle facing the empty portion do not tip over.

In accordance with a further aspect, the above-mentioned object is achieved by a drying device for drying cleaned container units, comprising a second movement device for movement of cleaned container bundles, comprising a plurality of cleaned container units, along a drying path, a drying unit for applying a drying fluid to the cleaned container units at least in portions along the drying path, and a second control device which is signal-coupled to the drying unit and is configured to set the drying unit as a function of a bundle spacing between two successive cleaned container bundles.

The invention is based, among other things, on the realization that drying devices for drying cleaned container units have a high energy requirement. In particular, the drying unit for applying the drying fluid to the cleaned container units has a high energy requirement, since a large amount of drying fluid has to be conveyed and/or circulated and the drying fluid has to be brought to a high temperature. The invention is further based on the realization that the disadvantages of bundle spacing described in the foregoing are also relevant to drying devices. In particular, high energy savings can be realized by an appropriate controller of the drying unit depending on the bundle spacing.

The functionalities of the control device described in the preceding may be provided in an analogous manner in the second control device. The features of the control device described in the foregoing can thus also be implemented by the second control device.

It is particularly preferred that the second control device is configured to put the drying unit into an energy-saving mode when a predefined bundle spacing between two successive container bundles is exceeded. Furthermore, the movement speed of the second movement device can be adjusted in such a manner that the bundle spacing between two successive container bundles is less than a predefined bundle spacing. The bundle spacing of the cleaning system can correspond to the bundle spacing for the drying device.

In accordance with a preferred embodiment of the drying device, the second control device is configured to adjust the drying device in such a manner that a drying fluid flow of the drying fluid and/or a temperature of the drying fluid is varied depending on the bundle spacing. In particular, it is preferred that the greater the bundle spacing, the lower the drying fluid flow is set. In particular, it is preferred that the drying fluid flow is reduced or deactivated at the bundle empty point.

The drying fluid flow may involve an exhaust air from the drying unit or a circulating air within the drying unit. A preferred embodiment of the drying device comprises a cleaning system according to any of the embodiments described in the preceding.

In accordance with a further aspect of the invention, the object mentioned at the outset is achieved by a method for cleaning container units, in particular with a cleaning system according to one of the embodiments described in the foregoing, comprising the steps of: moving container bundles, containing a plurality of container units, along a cleaning path at a movement speed, cleaning the container units within at least one cleaning portion of the cleaning path, putting the cleaning device into an energy-saving mode, in particular reducing a cleaning power or deactivating the cleaning device, if a predefined bundle distance between two successive container bundles is exceeded, and/or reducing a movement speed to adjust the predefined bundle distance. Preferably, the bundle spacing is detected.

Furthermore, information characterizing the bundle spacing can be provided and/or received. It is furthermore preferred to temper the cleaning fluid as a function of the bundle spacing and/or movement speed.

It is furthermore preferred to deactivate one, two, or more cleaning units depending on the movement speed and/or the bundle spacing. It is furthermore preferred to expose the container units to the cleaning fluid for a cleaning time, wherein the cleaning time substantially corresponds to the exposure time.

It is furthermore preferred to evacuate a fluid, particularly air, from the cleaning device. Furthermore, it is preferred to remove the cleaning fluid from the container units, particularly with a second fluid flow device, preferably with a fluid flow.

In accordance with a further aspect, the object mentioned at the outset is achieved by a method for drying cleaned container units, in particular with a drying device according to one of the embodiments described in the foregoing, comprising the steps of: moving cleaned container bundles containing a plurality of cleaned container units along a drying path at a movement speed, applying a drying fluid to the cleaned container units, providing the drying fluid in response to a bundle spacing between two successive cleaned container bundles.

It is preferred that a drying fluid flow rate of the drying fluid and/or a temperature of the drying fluid is varied as a function of the bundle spacing.

The methods and their possible further developments have features or method steps that make them particularly suitable to be used for a cleaning system and/or a drying device.

For further advantages, embodiment variants and embodiment details of the further aspects and their possible further embodiments, reference is also made to the previously given description regarding the corresponding features and further embodiments of the cleaning system.

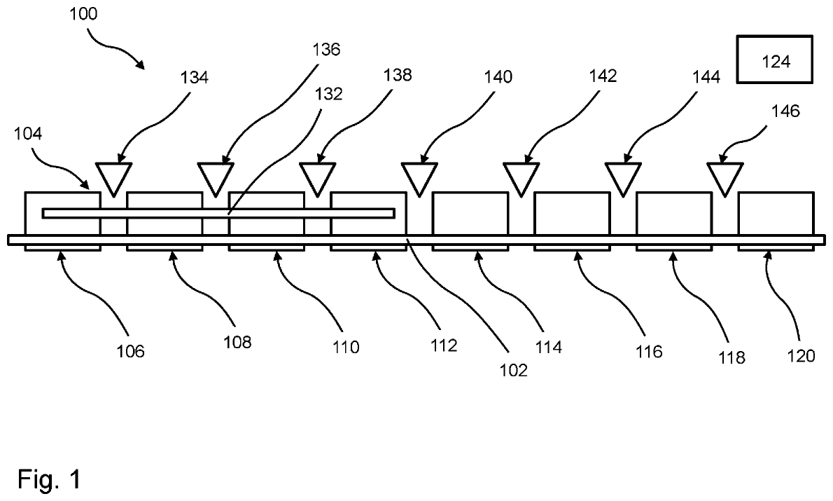

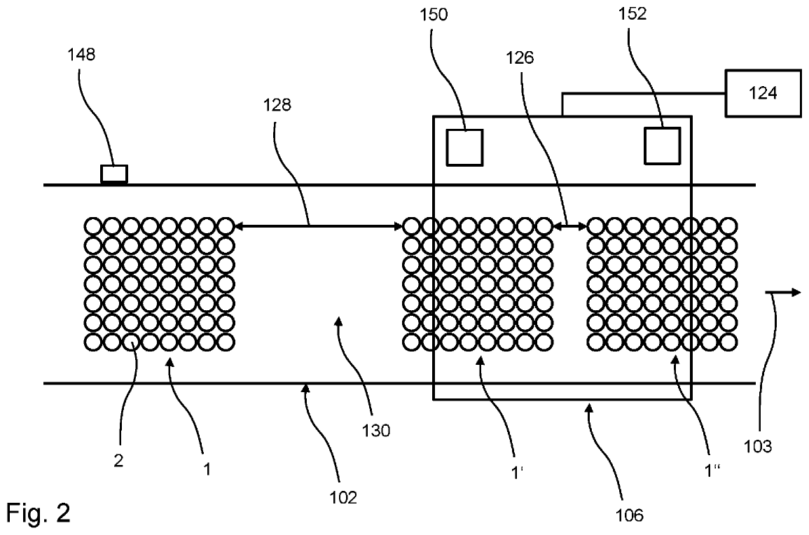

FIG. 1 shows a cleaning system 100 for cleaning container units 2 that are combined into container bundles 1, 1′, 1″. The cleaning system 100 comprises a movement device 102 arranged and designed to move the container bundles 1, 1′, 1″ along a cleaning path 104. The container bundles 1, 1′, 1″ are moved by the movement device 102 in the direction of movement 103 shown in FIG. 2.

The cleaning system 100 comprises a total of eight cleaning devices 106 to 120. The cleaning devices 106 to 120 are successively arranged along the cleaning path 104 or along the movement device 102.

A second fluid flow device 134 to 146 is arranged between each two cleaning devices 106 to 120, respectively, and designed to remove cleaning fluid from the container units 2.

Furthermore, the cleaning system 100 has a downholder 132 arranged and designed to allow the container units 2 to be arranged between the downholder 132 and the movement device 102. The downholder 132 acts in particular to stabilize the container units 2 in such a way that they do not tip over during intended operation.

The cleaning system 100 further comprises a control device 124 signal-coupled to the cleaning devices 106 to 120 and the movement device 102. The control device 124 is configured to place the cleaning devices 106 to 120 into an energy-saving mode when a predefined bundle spacing between two consecutive container bundles 1, 1′, 1″ is exceeded. This is particularly the case if an actual bundle spacing 126, 128 is greater than a predefined bundle spacing.

Particularly in FIG. 2, the bundle spacings 126, 128 are visualized. The bundle spacings 126, 128 show in particular a spacing of successive container bundles 1, 1′, 1″ in the direction of movement 103 for the movement device 102.

A bundle empty point is generally created by a bundle spacing. Exemplarily, the bundle empty point 130 between the two container bundles 1, 1′ is shown, which is caused by the second bundle spacing 128. A bundle empty point 130 is characterized in particular by the fact that no container units 2 are arranged at this location.

The control device 124 is furthermore configured to adjust a movement speed for the movement device 102 in such a way that the bundle spacing 126, 128 between two successive container bundles 1, 1′, 1″ is less than the predefined bundle spacing.

FIG. 2 furthermore shows that the cleaning system 100 has a distance detection unit 148. The distance detection unit 148 is arranged and designed to detect the bundle spacings 126, 128. The distance detection unit 148 is signal-coupled to the control device 124. For simplicity, this coupling is not shown in FIG. 2.

The cleaning device 106 comprises a temperature control unit 150 to temper the cleaning fluid to a temperature. In addition, the cleaning device 106 comprises a first fluid flow device 152 to flow air out of the cleaning device 106.

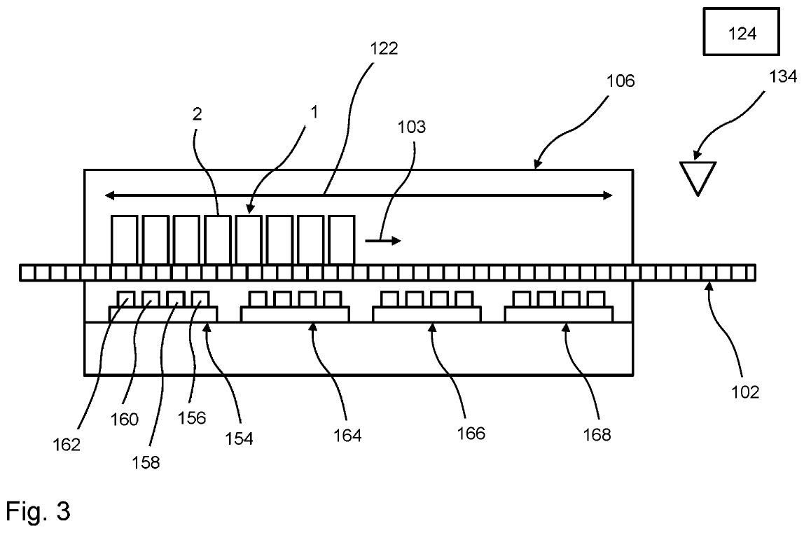

FIG. 3 shows a side view of the cleaning device 106. The container bundle 1 is conveyed through the cleaning device 106 by the movement device 102 in the direction of movement 103. The cleaning device 106 has the cleaning portion 122 within which the container units 2 are cleaned. The container units 2 are arranged with their open side facing downwards on the movement device 102.

The movement device 102 has fluid-permeable openings in such a way that a cleaning fluid dispensed from the cleaning units 154, 164, 166, 168 reaches the container units 2 in a vertically upward direction. The cleaning units 154, 164, 166, 168 each have four cleaning nozzles 156, 158, 160, 162. The control device 124 is configured to disable the cleaning units 154, 164, 166, 168 in response to the movement speed and/or bundle spacing 126, 128.

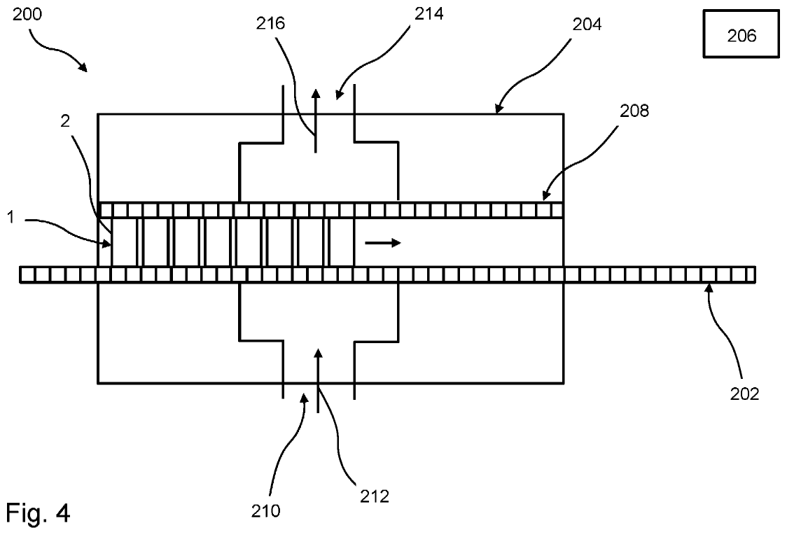

FIG. 4 shows a drying device 200 having a second movement device 202 and a drying unit 204. The drying unit 204 is signal-coupled to a second control device 206.

The drying unit 204 is designed to apply a drying fluid to the container units 2 at least in portions along a drying path.

The second control device 206 is configured to configure the drying unit 204 in response to a bundle spacing between two successive cleaned container bundles 1.

The drying unit 204 has a fluid inlet 210 and a fluid outlet 214. A fluid flow in the fluid inlet direction 212 passes through the fluid inlet 210 to the container units 2. The fluid flow may exit the drying unit 204 through the fluid outlet 214 in the fluid outlet direction 216.

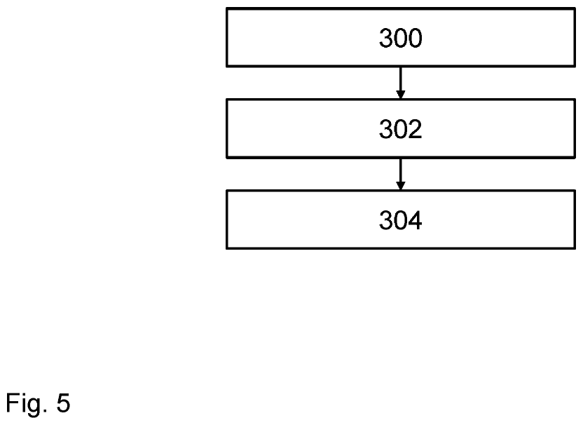

FIG. 5 shows a method for cleaning container units 2. In step 300, container bundles 1, 1′, 1″ containing a plurality of container units 2 are moved along a cleaning path 104 at a movement speed. At least partially in parallel, the container units 2 are cleaned in step 302 within at least one cleaning portion 122 of the cleaning path 104.

In step 304, also at least partially simultaneously to steps 300, 302, one, two, or more of the cleaning devices 106 to 120 are set to an energy-saving mode, in particular a cleaning power is reduced or the cleaning device is deactivated, if a predefined bundle spacing 126, 128 between two successive container bundles 1, 1′, 1″ is exceeded and/or the movement speed is reduced to adjust the predefined bundle spacing.

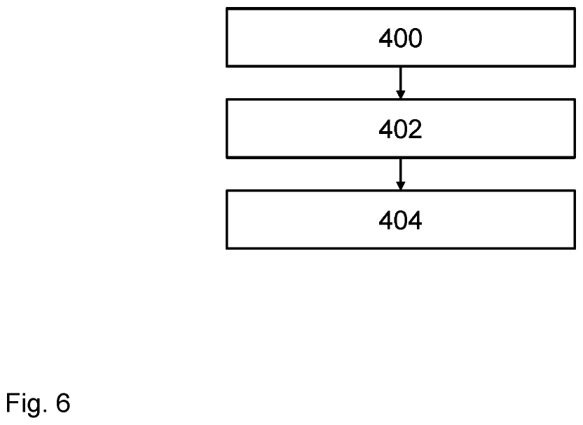

FIG. 6 shows a method for drying cleaned container units 2. In step 400, the cleaned container bundles 1, 1′, 1″ are moved along a drying path at a movement speed. At least partially simultaneously, a drying fluid is applied to the cleaned container units 2 in step 402. In step 404, the drying fluid is provided as a function of a bundle spacing 126, 128 between two successive cleaned container bundles 1, 1′, 1″.

REFERENCE NUMERALS

| | |
|---|---|
| 1, 1′, 1″ | container bundle |
| 2 | container units |
| 100 | cleaning system |
| 102 | movement device |
| 103 | direction of movement |
| 104 | cleaning path |
| 106 | cleaning device |
| 108 | cleaning device |
| 110 | cleaning device |
| 112 | cleaning device |
| 114 | cleaning device |
| 116 | cleaning device |
| 118 | cleaning device |
| 120 | cleaning device |
| 122 | cleaning portion |
| 124 | control device |
| 126 | first bundle spacing |
| 128 | second bundle spacing |
| 130 | bundle empty point |
| 132 | downholder |
| 134 | second fluid flow device |
| 136 | second fluid flow device |
| 138 | second fluid flow device |
| 140 | second fluid flow device |
| 142 | second fluid flow device |
| 144 | second fluid flow device |
| 146 | second fluid flow device |
| 148 | distance detection unit |
| 150 | temperature control unit |
| 152 | first fluid flow device |
| 154 | cleaning unit |
| 156 | cleaning nozzle |
| 158 | cleaning nozzle |
| 160 | cleaning nozzle |
| 162 | cleaning nozzle |
| 164 | cleaning unit |
| 166 | cleaning unit |
| 168 | cleaning unit |
| 200 | drying device |
| 202 | second movement device |
| 204 | drying unit |
| 206 | second control device |
| 208 | downholder |
| 210 | fluid inlet |
| 212 | fluid inlet direction |
| 214 | fluid outlet |
| 216 | fluid outlet direction |

1. A cleaning system for cleaning container units, in particular cans, comprising
a movement device arranged and designed to move container bundles including a plurality of container units along a cleaning path,
at least one cleaning device arranged and designed to clean the container units within at least one cleaning portion of the cleaning path, and
a control device signal-coupled to the at least one cleaning device and/or the movement device, which is configured,
to put the at least one cleaning device into an energy-saving mode when a predefined bundle spacing between two successive container bundles is exceeded, and/or
to set a movement speed of the movement device in such a manner that a bundle spacing between two successive container bundles is smaller than the predefined bundle spacing.

2. The cleaning system according to claim 1, wherein the control device is configured, upon placing the cleaning device into the energy-saving mode, to place the cleaning device in an idle mode and/or deactivate the cleaning device.

3. The cleaning system according to claim 1, comprising a distance detection unit signal-coupled to the control device and arranged and designed to detect the bundle spacing between two successive container bundles.

4. The cleaning system according to claim 1, wherein the control device is configured to compare the bundle spacing between two successive container bundles with the predefined bundle spacing.

5. The cleaning system according to claim 1, wherein the distance detection unit is a light barrier.

6. The cleaning system according to claim 1, comprising a temperature control unit signal-coupled to the control device for tempering a cleaning fluid, wherein the control device is configured to control the temperature control unit as a function of the bundle spacing and/or the movement speed.

7. The cleaning system according to claim 1, wherein the cleaning device has a plurality of cleaning units for dispensing the cleaning fluid, which are arranged and configured in such a manner that they can be deactivated individually and/or in groups, wherein the control device is configured to deactivate the cleaning units depending on the movement speed and/or the bundle spacing.

8. The cleaning system according to claim 1, wherein the cleaning units each have cleaning nozzles for dispensing the cleaning fluid, and the cleaning nozzles are separately controllable in such a manner that the cleaning nozzles can be separately deactivated.

9. The cleaning system according to claim 1, wherein the cleaning fluid has a predefined exposure time and the control device is configured to control the cleaning device, in particular the cleaning units, and/or to adjust the movement speed in such a manner that the container units are exposed to the cleaning fluid for a cleaning time, wherein the cleaning time substantially corresponds to the exposure time.

10. The cleaning system according to claim 1, comprising a first fluid flow device arranged and designed to evacuate a fluid, particularly air, from the cleaning device.

11. The cleaning system according to claim 1, comprising two cleaning devices, wherein a second fluid flow device is arranged and designed between the two cleaning devices in such a way as to remove cleaning fluid from the container units.

12. A drying device for drying cleaned container units, comprising
a second movement device for moving cleaned container bundles including a plurality of cleaned container units along a drying path,
a drying unit for applying a drying fluid to the cleaned container units at least in portions along the drying path, and
a second control device, which is signal-coupled to the drying unit and is configured to adjust the drying unit as a function of a bundle spacing between two successive cleaned container bundles.

13. The drying device according to claim 12, wherein the second control device is configured to adjust the drying unit in such a way that a drying fluid flow of the drying fluid and/or a temperature of the drying fluid is varied depending on the bundle spacing.

14. The drying device according to claim 12, comprising a cleaning system for cleaning container units, the cleaning system including
a movement device arranged and designed to move container bundles including a plurality of container units along a cleaning path,
at least one cleaning device arranged and designed to clean the container units within at least one cleaning portion of the cleaning path, and
a control device signal-coupled to the at least one cleaning device and/or the movement device, which is configured,
to put the at least one cleaning device into an energy-saving mode when a predefined bundle spacing between two successive container bundles is exceeded, and/or
to set a movement speed of the movement device in such a manner that a bundle spacing between two successive container bundles is smaller than the predefined bundle spacing.

15. A method for cleaning container units, in particular with a cleaning system according to claim 1, comprising the steps of:
moving container bundles including a plurality of container units along a cleaning path at a movement speed,
cleaning the container units within at least one cleaning portion of the cleaning path,
putting the cleaning device into an energy-saving mode, in particular reducing a cleaning power or deactivating the cleaning device, if a predefined bundle spacing between two successive container bundles is exceeded, and/or reducing a movement speed to adjust the predefined bundle spacing.

16. A method for drying cleaned container units, the method comprising the steps:
moving cleaned container bundles including a plurality of cleaned container units along a drying path at a movement speed,
applying a drying fluid to the cleaned container units, and
providing the drying fluid as a function of a bundle spacing between two successive cleaned container bundles.
